(19) United States
(12) Patent Application Publication
(10) Pub. No.: US 2009/0306276 A1
(43) Pub. Date: Dec. 10, 2009

(54) USE OF COMPOSITE MATERIALS BASED ON CARBON NANOTUBES AS THICKENING AGENTS FOR AQUEOUS SOLUTIONS

(75) Inventors: Stephanie Magnet, Morlanne (FR); Laurence Couvreur, Paris (FR); Olivier Guerret, La Tour de Salvagny (FR); Christelle Guerret-Piecourt, Mazerolles (FR)

Correspondence Address: ARKEMA INC.;PATENT DEPARTMENT - 26TH FLOOR, 2000 MARKET STREET, PHILADELPHIA, PA, 19103-3222, US

(73) Assignees: Arkema France, Colombes (FR); C.N.R.S., Paris Cedex 16 (FR)

(21) Appl. No.: 12/301,108

(22) PCT Filed: May 16, 2007
(86) PCT No.: PCT/FR07/51286

§ 371 Date: Jul. 10, 2009

Related U.S. Application Data
(60) Provisional application No. 60/830,148, filed on Jul. 11, 2006.

(30) Foreign Application Priority Data
May 18, 2006 (FR) 06.51816

(51) Int. Cl. C08L 31/00

(52) U.S. Cl. 524/556

(57) ABSTRACT

The present invention relates to the use of composites based on carbon nanotubes as viscosity enhancers for aqueous solutions, characterized in that said composite comprises carbon nanotubes (CNTs) and at least one hydrophilic (co) polymer.

More particularly, the invention relates to the use of the composites described above as viscosity enhancers in industrial sectors such as, especially, the papermaking sector, and in particular for coating paper and for weighting paper, in the oil sector, or else in the paint, water-treatment, detergent, ceramic, cement, hydraulic-binder, public-works, ink, varnish and textile-sizing sectors.

### TECHNICAL FIELD

The present invention relates to the use of composites based on carbon nanotubes as viscosity enhancers for aqueous solutions.

### PRIOR ART

In the current state of the art, the viscosity enhancers used to increase the viscosity of aqueous solutions are natural polymers, such as polysaccharides and cellulose derivatives, but also synthetic polymers of the acrylic or vinyl or urethane-based type, such as poly(meth)acrylamides, optionally partially hydrolysed, and poly(meth)acrylates, and also copolymers thereof. These polymers develop a viscosity thanks to their molar mass and to the interchain ionic repulsions. The mechanism governing the viscosity is due to an increase in the hydrodynamic volume and to interchain repulsions.

However, in the presence of electrolytes or surfactants, or when they are subjected to high operating temperatures, these polymers do not always develop good thickening properties. This is manifested by a substantial reduction in their thickening power. In addition, it is found that aqueous solutions containing these polymers are not very stable over time.

It has now been discovered that the use of a composite based on carbon nanotubes as a viscosity enhancer for aqueous solutions allows these problems to be overcome.

### SUMMARY OF THE INVENTION

The present invention therefore relates to the use of a composite based on carbon nanotubes as viscosity enhancer for aqueous solutions, characterized in that said composite comprises carbon nanotubes (CNTs) and at least one hydrophilic (co)polymer.

According to the invention, the (co)polymer is adsorbed and/or grafted on the surface of the CNTs in an irreversible manner. The expression “irreversibly adsorbed (co)polymer” is understood to mean a polymer that is no longer extractable from the CNT by various washings of the CNT/polymer mixture with water.

The WO 03/106600 and WO 03/050332 disclose CNTs aqueous dispersions obtained by dispersing a compound in particular polymeric in water and by adding the CNTs thereof. These documents do not disclose the use of a composite containing a (co)polymer adsorbed and/or grafted on the surface of CNTs as viscosity enhancer.

According to the invention, the CNT/hydrophilic (co)polymer mass ratio is between 1 and 99%, advantageously between 5 and 50% and preferably between 5 and 35%.

Carbon nanotubes are composed of wound graphitic sheets terminating in hemispheres consisting of pentagons and hexagons with a structure close to that of fullerenes and have a tubular structure with a diameter ranging between 0.4 and 50 nm, preferably less than 100 nm, and a very high length/diameter ratio, typically greater than 10 and often greater than 100. According to the invention, the CNTs are single-walled, double-walled and/or multi-walled carbon nanotubes.

Carbon nanotubes may be prepared using various methods, such as electrical discharge, laser ablation or chemical vapour deposition. Among these techniques, the latter seems to be the only one capable of ensuring that a large quantity of carbon nanotubes can be manufactured. The reader may for example refer more particularly to documents WO 86/03455 and WO 03/002456 for the preparation of separate or non-aggregated multi-walled carbon nanotubes.

The term “hydrophilic (co)polymers” is understood to mean (co)polymers that are composed of at least 50 wt % of hydrophilic monomers and consequently are readily dispersible in water.

The hydrophilic monomers may be ionic (cationic or anionic) monomers (A), neutral monomers (B) and/or amphoteric monomers (C).

The hydrophilic monomers according to the invention may be selected from styrene sulphonate (A), acrylic acid, methacrylic acid, itaconic acid, maleic acid or its salts, maleic anhydride, alkyl or alkoxy- or aryloxypolyalkylene glycol maleates or hemi-maleates, fumaric acid, 2-acrylamido-2-methyl-1-propanesulphonic acid in acid form or partially neutralized (B or A depending on whether they are neutralized or not), 2-methacrylamido-2-methyl-1-propanesulphonic acid in acid form or partially neutralized (B or A depending on whether they are neutralized or not), 3-methacrylamido-2-hydroxy-1-propanesulphonic acid in acid form or partially neutralized (B or A depending on whether they are neutralized or not), acrylamidomethylpropane-sulphonic acid (AMPS) in acid form or partially neutralized (B or A depending on whether they are neutralized or not), allylsulphonic acid, methallylsulphonic acid, allyloxybenzenesulphonic acid, methallyloxybenzenesulphonic acid, 2-hydroxy-3-(2-propenyloxy)propanesulphonic acid, 2-methyl-2-propene-1-sulphonic acid, ethylenesulphonic acid, propenesulphonic acid, 2-methylsulphonic acid, styrenesulphonic acid and their salts (B or A depending on whether they are neutralized or not), vinylsulphonic acid, sodium methallylsulphonate, sulphopropyl acrylate or methacrylate (B or A depending on whether they are neutralized or not), sulphomethylacrylamide, sulphomethylmethacrylamide (B) or else selected from acrylamide, methylacrylamide, n-methylolacrylamide, n-acryloylmorpholine, ethylene glycol methacrylate, ethylene glycol acrylate, propylene glycol methacrylate, propylene glycol methacrylate, propylene glycol acrylate (B), propenephosphonic acid (B or A depending on whether they are neutralized or not), ethylene or propylene glycol (B) methacrylate or acrylate (A) phosphate or else vinylpyridine (B), vinylpyrrolidinone (B), vinylpyrrolidone (B), aminoalkyl methacrylates such as 2-(dimethylamino)ethyl methacrylate (DAEMA), methacrylates of amine salts such as [2-(methacryloyloxy)ethyl]trimethylammonium chloride or sulphate or [2-(methacryloyloxy)ethyl]dimethyl-benzylammonium chloride or sulphate, methacrylamido-propyltrimethylammonium chloride or sulphate (A), trimethylammonioethyl methacrylate chloride or sulphate, and also their acrylate and acrylamide homologues whether quaternized (A) or not, such as 2-(dimethylamino)ethyl acrylate (DMAEA), acrylates of amine salts, such as [2-(acryloyloxy)ethyl]trimethyl-ammonium chloride or sulphate or [2-(acryloyloxy)-ethyl]dimethylbenzylammonium chloride or sulphate and/or ammonium dimethyldiallyl chloride, and also their mixtures (A).

The hydrophilic (co)polymers according to the invention may be gradient and/or random block copolymers, one of the blocks of which is hydrophilic in nature and represents at least 50% of the copolymer by weight, the other block(s) being formed of at least one ethylenically unsaturated monomer copolymerizable with the hydrophilic monomer(s), by means of which the final copolymer is dispersible in water.

According to the invention, the number of blocks is advantageously between 2 and 5.

The ethylenically unsaturated monomers may be selected from alkyl(meth)acrylates, vinyl aromatic or styrene monomers and their substituted derivatives, and/or diene monomers.

In particular, the (meth)acrylates are those of the formulae CH₂═C(CH₃)—COOR^{o} and CH₂═CH—COO—R^{o}, respectively, in which R^{o} is selected from linear or branched, alkyl radicals containing 1 to 18 carbon atoms, primary, secondary or tertiary radicals, cycloalkyl radicals containing 5 to 18 carbon atoms, (C₁-C₁₈) alkoxy)-C₁-C₁₈) alkyl radicals, (C₁-C₁₈) alkylthio-(C₁-C₁₈)alkyl radicals, aryl and arylalkyl radicals, all these radicals possibly being substituted with at least one halogen (such as fluorine) atom and/or at least one hydroxyl group after this hydroxyl group has been protected, the above alkyl groups being linear or branched; and glycidyl, norbornyl or isobornyl (meth)acrylates.

As examples of methacrylates, mention may be made of methyl, ethyl, 2,2,2,-trifluoroethyl, n-propyl, isopropyl, n-butyl, sec-butyl, tert-butyl, n-amyl, i-amyl, n-hexyl, 2-ethylhexyl, cyclohexyl, octyl, i-octyl, nonyl, decyl, lauryl, stearyl, phenyl, benzyl, β-hydroxyethyl, isobornyl, hydroxypropyl and hydroxybutyl methacrylates.

As examples of acrylates of the above formula, mention may be made of methyl, ethyl, n-propyl, isopropyl, n-butyl, sec-butyl, tert-butyl, hexyl, 2-ethylhexyl, isooctyl, 3,3,5-trimethylhexyl, nonyl, isodecyl, lauryl, oxtadecyl, cyclohexyl, phenyl, methoxymethyl, methoxyethyl, ethoxymethyl, ethoxyethyl and perfluorooctyl acrylates.

The term “vinyl aromatic monomer” is understood for the purpose of the present invention to mean an ethylenically unsaturated aromatic monomer such as styrene, vinyltoluene, α-methylstyrene, 4-methylstyrene, 3-methylstyrene, 4-methoxystyrene, 2-hydroxymethylstyrene, 4-ethylstyrene, 4-ethoxystyrene, 3,4-dimethylstyrene, 2-chlorostyrene, 3-chlorostyrene, 4-chloro-3-methylstyrene, 3-tert-butylstyrene, 2,4-dichlorostyrene, 2,6-dichlorostyrene and 1-vinylnaphthalene.

As vinyl esters, mention may be made of vinyl acetate, vinyl propionate, vinyl chloride and vinyl fluoride.

As vinylidene monomer, mention may be made of vinylidene fluoride.

The term “diene monomer” is understood to mean a diene selected from linear or cyclic, conjugated or unconjugated, dienes such as, for example, butadiene, 2,3-dimethylbutadiene, isoprene, 1,3-pentadiene, 4-pentadiene, 4-hexadiene, 1,5-hexadiene, 1,9-decadiene, 5-methylene-2-norbornene, 5-vinyl-2-norbornene, 2-alkyl-2,5-norbonadienes, 5-ethylene-2-norbornene, 5-(2-propenyl)-2-norbornene, 5-(5-hexenyl)-2-norbornene, 1,5-cyclooctadiene, bicyclo[2.2.2]octa-2,5-diene, cyclopentadiene, 4,7,8,9-tetrahydriondene and isopropylidene tetrahydroindene.

The hydrophilic (co)polymers according to the invention may be obtained by conventional or controlled radical polymerization, by ionic polymerization, by polyaddition or by polycondensation, it being understood that certain monomers may be polymerized using one or more of these polymerization techniques.

The composites according to the invention may principally be prepared in two modes:
either by CNTs being brought into contact with/dispersed in a molten polymer, a blend of molten polymers or a solution of one or more polymers in a solvent;
or by CNTs being brought into contact with/dispersed in a monomer, a blend of monomers, a solution of one or more monomers in a solvent or one or more polymers dissolved in one or more monomers.

Before any chemical modification, the carbon nanotubes according to the invention may advantageously be physically or chemically purified, especially by washing them using acid solutions (for example sulphuric acid and/or hydrochloric acid solutions) so as to strip them of mineral and metallic impurities and/or by treating them with sodium hypochlorite so as to obtain a larger quantity of oxygen-containing functional groups. The CNTs may also be ground before being brought into contact with the monomers or polymers.

The CNTs may be brought into contact with the monomers or polymers in various ways:
if the monomer or polymer is in liquid form, the contacting of the CNT powder with the monomer or polymer corresponds for example to a dispersion, either by direct introduction, by pouring the monomer or polymer into the powder or, on the contrary, by introducing the monomer or polymer drop by drop into the CNT powder, or by atomizing or nebulizing the monomer or polymer using an atomizer and spraying it onto the CNT powder.

The dispersion method may also take place by pouring the CNT powder into the monomer or polymer solution, which may or may not be in the form of a fluid film or fine droplets (dew) deposited on a solid surface:
if the monomer or polymer is in gaseous form, the contacting of the CNT powder with the monomer or polymer corresponds to an adsorption of monomer or polymer vapour, possibly transported by a gas, preferably an inert gas;
if the monomer or polymer is in solid form, the contacting of the CNT powder with the monomer or polymer corresponds to powder blending or dry blending and must be followed by a heat treatment, during which the monomer or polymer passes into a liquid or gaseous form so as to ensure intimate and homogenous mixing of the monomer or polymer with the CNTs.

The CNTs may also be dispersed in the monomer or polymer using a preliminary step of dissolving the monomer or polymer, in the presence of the CNTs, in a solvent with a CNT/monomer or CNT/polymer concentration generally less than 30%, advantageously less than 20% and preferably less than 15%.

The solvent optionally present with the monomers or polymers may be selected from the following: water; cyclic or linear ethers; alcohols; ketones; aliphatic esters; acids, such as for example acetic acid, propionic acid or butyric acid; aromatic solvents, such as benzene, toluene, xylene or ethylbenzene; halogenated solvents, such as dichloromethane, chloroform or dichloroethane; alkanes, such as pentane, n-hexane, cyclohexane, heptane, octane, nonane or dodecane; amides, such as dimethylformamide (DMF); dimethyl sulphoxide (DMSO), by themselves or as mixtures.

In this case, said preliminary step will be followed by a solvent evaporation step, preferably with stirring, so as to recover the composition in powder form. Advantageously, a filtration method may be used so as to shorten the cycle time while obtaining the CNT powder/monomer or polymer composition in dry form.

If monomers or polymers of different physical form are introduced, the contacting of the compounds of different physical form with the CNTs will preferably take place in succession: for example, adsorption of the monomer and/or polymer in gaseous form on the CNTs followed by dry blending with a second monomer or polymer in solid form, or in liquid form.

This contacting/dispersing step may be carried out in conventional synthesis reactors, in fluidized-bed reactors or in mixing equipment of the Z-blade mixer or Brabender mixer type, or in an extruder or in any other mixing equipment of the same type known to those skilled in the art.

After this first contacting/dispersing step, the CNT/monomer or polymer mixture remains in solid form and retains good flowability properties (it does not set into a solid mass). If necessary, it may or may not be mechanically stirred, or put into suspension in a gas in the form of a fluidized bed or not.

The amount of monomer or polymer introduced is such that, after this contacting/dispersing step, it is below the threshold for obtaining a liquid CNT suspension, or a paste in which the CNT particles are partially or completely bound together. This threshold depends in particular on the capacity of the monomer or polymer to impregnate the CNT powder and, if the monomer or polymer is a liquid or a solution, it depends on the viscosity of the liquid introduced.

If the monomer is acrylic acid, this quantity is generally between 30 and 90%.

The method of obtaining the composites according to the invention includes an optional heat treatment of the powder after the contacting/dispersing step.

This heat treatment consists in heating the powder obtained after the contacting/dispersing step in such a way that the physico-chemical properties of the powder are modified by this heat treatment.

If a liquid containing monomers has been introduced into the contacting/dispersing step (one or more monomers in the liquid state, solution of one or more monomers, etc.), this heat treatment step may consist for example in a heating operation for polymerizing the monomers and/or a strong physical adsorption and/or a chemical adsorption with the creation of bonds between the CNTs and a fraction of the monomer(s) or polymer(s) formed.

The creation of bonds between the CNTs and the polymer synthesized in situ via the monomers introduced in the first step, or with the polymer added during the first step, is characterized in that a portion of this polymer created in situ or added to the CNTs before the heat treatment can no longer be extracted from the CNTs by various washing operations using selective solvents for the polymers, whereas the same washing operations on the (CNT/monomer or polymer) mixture resulting from the contacting/dispersing step allow all the monomer or polymer to be extracted from the CNTs.

If a solution of one or more (co)polymers is used in the contacting/dispersing step, the heat treatment causes strong physical adsorption or chemical adsorption with the creation of covalent bonds between the CNTs and the polymer and/or the continuation of the polymerization, with for example an increase in the molar mass of the polymer.

If the monomer or polymer is in liquid form or dissolved in a solvent, the heat treatment may also improve the distribution between the liquid and the CNTs.

When it is desired for polymerization to take place during the heat treatment, the temperature and pressure conditions of this heat treatment step will be in accordance with the usual polymerization conditions known to those skilled in the art. During the polymerization, the atmosphere may or may not be inert, depending on the nature of the monomers and polymers in question.

In the case of acrylic acid polymerization during the heat treatment, the pressure is in general between 0 and 300 kPa and the temperature between 40 and 150° C. The heating time is then between 5 and 1000 minutes and more precisely between 300 and 600 minutes. Advantageously, the heat treatment takes place according to the following thermal cycle: firstly, a temperature hold at 64° C. for 150 to 500 minutes followed by a second temperature hold at 120° C. for 100 to 200 minutes, before cooling to room temperature, the pressure also remaining at atmospheric pressure.

After the heat treatment, the product obtained remains in the form of a solid powder and retains good flowability properties (it does not set into a solid mass). After this step, the product obtained is below the threshold for obtaining either a liquid CNT suspension or a paste in which the CNT particles are partially or completely bound together.

The method of obtaining the compositions according to the invention includes an optional step of separating the compounds that are present in the CNT-based powder composition but not bonded to the composition after the contacting/dispersing step or the physical and/or chemical adsorption heat treatment. This step may for example consist in a washing operation using a solution containing a solvent for the compounds to be removed and/or of a drying operation in order to devolatilize the volatile products. For thorough washing, a solvent solution may for example be used. The washing may be carried out in several steps, preferably between 1 and 5 steps, in order to improve the separation of the non-bonded compounds. It is also possible to combine several separation techniques, such as washing and drying.

The drying consists in placing the volatile compounds under temperature and pressure conditions such that their desorption is facilitated. Thus, it may be preferable to use a partial vacuum at a temperature lower than the chemical decomposition temperature of the compounds, more particularly below 200° C., and a pressure of between 100 Pa and 200 kPa.

To speed up this extraction of the volatile compounds, it is also possible to start with a first filtration phase. It is possible to carry out the final drying phase, for example, with stirring so as to recover a non-agglomerated CNT powder, which would be outside the scope of the invention.

In the case of a method with no heat treatment, and if the monomer is acrylic acid, the purification/separation step may consist of washing with an aqueous alcohol solution and more particularly a 50% aqueous ethanol solution.

The composites according to the invention may advantageously replace the conventionally employed viscosity enhancers and/or thickeners for aqueous solutions.

More particularly, the invention relates to the use of the composites described above as viscosity enhancers in industrial sectors such as, especially, the papermaking sector, and in particular for coating paper and for weighting paper, in the oil sector, or else in the paint, water-treatment, detergent, ceramic, cement, hydraulic-binder, public-works, ink, varnish and textile-sizing sectors.

The invention also relates to an aqueous dispersion comprising the composite described above, used as a viscosity enhancer. The percentage by weight of composite in the dispersion is between 0.1 and 10%, advantageously between 0.1 and 5% and preferably between 0.1 and 3%.

The aqueous dispersions according to the invention, because of the presence of the carbon nanotubes, have a high viscosity and a high stability with time. In the event of prolonged exposure to high temperatures, especially temperatures above 150° C., they undergo no chemical degradation, and they retain a high viscosity. They also have a very high resistance to shear forces. Furthermore, they are very insensitive to multivalent metal ions, and very resistant to oxygen and carbon dioxide, and they are also stable in the presence of salts.

The invention is not limited to aqueous dispersions consisting of water and the composite described above, but also relates to aqueous solutions comprising, in particular, inorganic salts and, optionally, one or more water-miscible organic solvents. The dispersion may also contain other constituents, such as plasticizers, deflocculants, anti-foam agents, corrosion inhibitors, etc.

The following examples illustrate the present invention without however limiting its scope.

### EXAMPLES

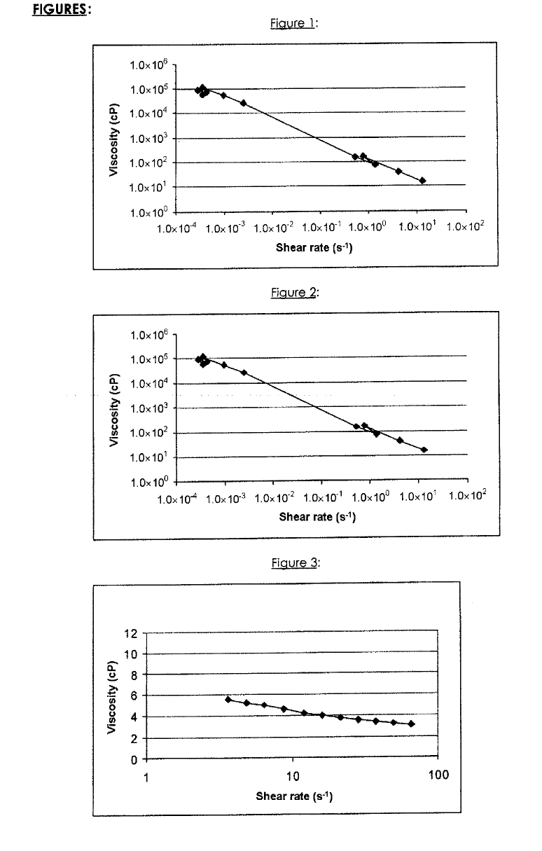

FIGS. 1 to 3 show the variation in the viscosity of aqueous dispersions of each of Examples 1 to 3 described below, at 50° C., as a function of the shear rate.

The viscosity was measured in a Couette geometry using an SR200 rheometer.

The carbon nanotubes used were obtained by the CVD process, by decomposing ethylene at 650°-700° C. on an alumina-supported iron catalyst. These nanotubes were multi-walled nanotubes with an external diameter of around 10 to 30 nm and a total content of mineral impurities, in the form of iron oxide and aluminium oxide, of 6.4%.

In Example 1, the dispersion tested was an aqueous (distilled water) solution containing 2 wt % of CNT composites grafted by polyacrylic acid (PAA) obtained by polymerizing acrylic acid. The polyacrylic acid had a number-average molecular weight (Mₙ) of about 5000 g/mol and a polydispersity index of 1.4. The CNT/PAA ratio by weight was about 30/70. The CNT content of the aqueous suspension obtained was therefore about 6000 ppm. FIG. 1 corresponds to the dispersion of Example 1.

In Example 2, the tested dispersion was an aqueous (distilled water) solution containing 1 wt % of CNT composites grafted by a PAA-PMA (neutralized polyacrylic acid/polymethyl acrylate) block copolymer. The PAA block had a number-average molecular weight of about 5000 g/mol and a polydispersity index of 1.4, and the PMA block had a number-average molecular weight of about 10000 g/mol. The CNT/PAA-PMA ratio by weight was about 10/90. The CNT content of the aqueous suspension obtained was therefore about 1000 ppm. FIG. 2 corresponds to the dispersion of Example 2.

In Example 3, the dispersion tested was an aqueous (distilled water) solution containing 1 wt % of CNT composites in the presence of PAA obtained by a controlled radical polymerization process, said PAA being adsorbed on the CNT.

An aqueous solution of polyacrylic acid (PAA) obtained by a controlled radical polymerization process, with a number-average molecular weight of about 10000 g/mol and a polydispersity index of 1.3, was added at room temperature to the CNT powder and mechanically stirred for 30 minutes. The CNT/PAA ratio by weight was about 30/70. The CNT content of the aqueous suspension obtained was therefore about 3000 ppm. FIG. 3 corresponds to the dispersion of Example 3.

These three examples demonstrate that the addition of CNTs, surface-modified by or mixed with a hydrophilic polymer, to an aqueous distilled-water solution makes it possible for the viscosity of the solution to be appreciably increased. Specifically, the water had a viscosity of 0.7 cP at 50° C.

1. A composite viscosity enhancer for aqueous solutions comprising carbon nanotubes (CNTs) and at least one hydrophilic (co)polymer.

2. The composite according to claim 1, characterized in that the (co)polymer is adsorbed and/or grafted on the surface of the CNTs in an irreversible manner.

3. The composite according to claim 1, characterized in that the CNT/hydrophilic (co)polymer mass ratio is between 1 and 99%.

4. The composite according to claim 1, characterized in that said (co)polymers are composed of at least 50 wt % of hydrophilic monomer(s).

5. The composite according to claim 1, characterized in that the hydrophilic monomers are selected from ionic monomers (A), neutral monomers (B), amphoteric monomers (C) or mixtures thereof.

6. The composite according to claim 1, characterized in that said hydrophilic monomers are selected from styrene sulphonate, acrylic acid, methacrylic acid, itaconic acid, maleic acid or its salts, maleic anhydride, alkyl or alkoxy- or aryloxypolyalkylene glycol maleates or hemi-maleates, fumaric acid, 2-acrylamido-2-methyl-1-propanesulphonic acid in acid form or partially neutralized, 2-methacrylamido-2-methyl-1-propanesulphonic acid in acid form or partially neutralized, allylsulphonic acid, methallylsulphonic acid, allyloxybenzenesulphonic acid, methallyloxybenzenesulphonic acid, 2-hydroxy-3-(2-propenyloxy)propanesulphonic acid, 2-methyl-2-propene-1-sulphonic acid, ethylenesulphonic acid, propenesulphonic acid, 2-methylsulphonic acid, styrenesulphonic acid and their salts, vinylsulphonic acid, sodium methallylsulphonate, sulphopropyl acrylate or methacrylate, sulphomethylacrylamide, sulphomethylmethacrylamide, acrylamide, methylacrylamide, n-methylolacrylamide, n-acryloylmorpholine, ethylene glycol methacrylate, ethylene glycol acrylate, propylene glycol methacrylate, propylene glycol methacrylate, propylene glycol acrylate, propenephosphonic acid, ethylene or propylene glycol methacrylate or acrylate phosphate, vinylpyridine, vinylpyrrolidinone, vinylpyrrolidone, aminoalkyl methacrylates, 2-(dimethylamino)ethyl methacrylate (DAEMA), methacrylates of amine salts, [2-(methacryloyloxy)ethyl]trimethylammonium chloride or sulphate, [2-(methacryloyloxy)ethyl]dimethylbenzylammonium chloride or sulphate, methacrylamido-propyltrimethylammonium chloride or sulphate, trimethylammonioethyl methacrylate chloride or sulphate, and their acrylate and acrylamide homologues whether quaternized or not, 2-(dimethylamino)ethyl acrylate (DMAEA), acrylates of amine salts, [2-(acryloyloxy)ethyl]trimethylammonium chloride or sulphate, [2-(acryloyloxy)ethyl]dimethylbenzylammonium chloride or sulphate ammonium dimethyldiallyl chloride, or mixtures thereof.

7. The composite according to claim 1, characterized in that said hydrophilic (co)polymers are gradient and/or random block copolymers having at least a first block and a second block, said first block of which is hydrophilic and represents at least 50% of the (co)polymer.

8. The composite according to claim 7, characterized in that said second block is formed from at least one ethylenically unsaturated monomer copolymerizable with the hydrophilic monomer(s), by means of which the final copolymer is dispersible in water.

9. The composite according to claim 8, characterized in that the ethylenically unsaturated monomer is selected from alkyl (meth)acrylates, styrene monomers and their substituted derivatives, diene monomers or mixtures thereof.

10. The composite according to claim 1, characterized in that the composite is obtained by bringing said CNTs into contact with a molten polymer, a blend of molten polymers or a solution of one or more polymers in a solvent.

11. The composite according to claim 1, characterized in that the composite is obtained by dispersing said CNTs in a monomer, a blend of monomers, a solution of one or more monomers in a solvent or one or more polymers dissolved in one or more monomers.

12. The composite according to claim 1, characterized in that the composite is obtained by bringing said CNTs into contact with a monomers or a polymer in a powder form.

13-14. (canceled)

15. The composite according to claim 1, characterized in that the CNT/hydrophilic (co)polymer mass ratio is between 5 and 50%.

16. The composite according to claim 1, characterized in that the CNT/hydrophilic (co)polymer mass ratio is between 5 and 35%.
